(19) United States
(12) Patent Application Publication
(10) Pub. No.: US 2016/0105301 A1
(43) Pub. Date: Apr. 14, 2016

(54) DETECTOR AND METHOD FOR DETECTING IQ SWAP

(71) Applicant: Novatek Microelectronics Corp., Hsinchu (TW)

(72) Inventor: Chung-Hsien Hsieh, Hsinchu County (TW)

(21) Appl. No.: 14/543,893

(22) Filed: Nov. 18, 2014

(30) Foreign Application Priority Data
Oct. 8, 2014 (TW) 103135018

(51) Int. Cl. H04L 27/22

(52) U.S. Cl. CPC H04L 27/22

(57) ABSTRACT

A detector and a method for detecting IQ swap are provided. The detector includes a first correlator, a second correlator and a comparator. The first correlator calculates a first correlation value between a received symbol stream and a first conjugated symbol stream. The received symbol stream is generated by a transmission of a known symbol stream through a transmission channel. The first conjugated symbol stream is conjugate complex of the known symbol stream. The second correlator calculates a second correlation value between the first conjugated symbol stream and a second conjugated symbol stream. The second conjugated symbol stream is conjugate complex of the received symbol stream. In accordance with a relationship between the first and second correlation values, the comparator determines whether an in-phase component and a quadrature component in the received symbol stream have been swapped.

### CROSS-REFERENCE TO RELATED APPLICATION

This application claims the priority benefit of Taiwan application serial no. 103135018, filed on Oct. 8, 2014. The entirety of the above-mentioned patent application is hereby incorporated by reference herein and made a part of this specification.

### BACKGROUND OF THE INVENTION

1. Field of the Invention

The invention relates to a communication device, and more particularly, relates to a detector and a method for detecting in-phase component (I) and quadrature component (Q) swap.

2. Description of Related Art

In a digital video broadcasting (DVB) system such as DVB-S2 or DVB-T2, because a spectrum inversion may be performed several times during a signal processing, signals received by a receiver device from an antenna may be signals with a correct spectrum or signals with an inverted spectrum. Among them, the signals with the inverted spectrum are equivalent to, in terms of time domain, swap of in-phase component (I) and quadrature component (Q) in the correct spectrum. In order to prevent from errors occurring in subsequent demodulation of a demodulator due to the signals with the inverted spectrum, the receiver device needs to determine whether the received signals include the correct spectrum or the inverted spectrum first, so as to correct the inverted spectrum to be the correct spectrum.

The existing IQ swap detector needs to calculate Equation 1 below in order to obtain a detection result X. In Equation 1, yₙ represents an input signal of the IQ swap detector at a time point n (i.e., a currently-received symbol), yₙ₋₁ represents an input signal of the IQ swap detector at a time point n−1 (i.e., a previously-received symbol), Cₙ represents a training symbol with π/2 binary phase shift keying (BPSK) modulation at the time point n, Cₙ₋₁ represents a training symbol at the time point n−1, and (CₙCₙ₋₁)* represents a conjugate symbol of CₙCₙ₋₁. The training symbol stream Cₙ may refer to the related documentation for the DVB-S2 system communication protocol, which is omitted hereinafter.

$$X = {\sum }_{n} {y}_{n} {{y}_{n - 1} ( {C}_{n} {C}_{n - 1} )}^{*} \qquad Equation 1$$

In any case, the existing IQ swap detector requires a complex multiplier for calculating a product of yₙ and yₙ₋₁. However, the complex multiplier has complex circuitry and occupies a considerably large chip area. Moreover, the existing IQ swap detector can only detect whether the in-phase component and the quadrature component are swapped by utilizing a characteristic of the training symbol stream in the DVB-S2 system: CₙCₙ₋₁=±j, in which j=\sqrt{−1}.

### SUMMARY OF THE INVENTION

The invention is directed to a detector and a method for detecting IQ swap, which are capable of determining whether an in-phase component and an quadrature component are swapped.

The IQ swap detector according the embodiments of the invention includes a conjugate circuit, a first correlator circuit, a second correlator circuit and a comparator circuit. The first correlator circuit receives a first conjugated symbol stream and a received symbol stream, and calculates a first correlation value between the received symbol stream and the first conjugated symbol stream. The received symbol stream is generated by a transmission of a known symbol stream through a transmission channel, and the first conjugated symbol stream is conjugate complex of the known symbol stream. The second correlator circuit receives the first conjugated symbol stream and a second conjugated symbol stream, and calculates a second correlation value between the first conjugated symbol stream and the second conjugated symbol stream. The second conjugated symbol stream is conjugate complex of the received symbol stream. The comparator circuit is coupled to the first correlator circuit to receive the first correlation value. The comparator circuit is coupled to the second correlator circuit to receive the second correlation value. The comparator circuit determines whether an in-phase component and a quadrature component in the received symbol stream are swapped according to a relationship between the first correlation value and the second correlation value.

The method for detecting IQ swap according to the embodiments of the invention includes: calculating a first correlation value between a received symbol stream and a first conjugated symbol stream by a first correlator circuit, wherein the received symbol stream is generated by a transmission of a known symbol stream through a transmission channel, and the first conjugated symbol stream is conjugate complex of the known symbol stream; calculating a second correlation value between the first conjugated symbol stream and a second conjugated symbol stream by a second correlator circuit, wherein the second conjugated symbol stream is conjugate complex of the received symbol stream; and determining whether an in-phase component and a quadrature component in the received symbol stream are swapped according to a relationship between the first correlation value and the second correlation value by a comparator circuit.

The detector and the method for detecting IQ swap according to the embodiments of the invention are capable of detecting whether the in-phase component and the quadrature component are swapped, and calculating the product of currently-received symbol yₙ and the previously-received symbol yₙ₋₁ without using the complex multiplier.

To make the above features and advantages of the disclosure more comprehensible, several embodiments accompanied with drawings are described in detail as follows.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic diagram illustrating a communication system according to an embodiment of the invention.

FIG. 2 is a block diagram illustrating circuitry of the receiver device depicted in FIG. 1 according to an embodiment of the invention.

FIG. 3 is a flowchart illustrating operation of the receiver device depicted in FIG. 2 according to an embodiment of the invention.

FIG. 4 is a block diagram illustrating circuitry of the IQ swap detector depicted in FIG. 2 according to an embodiment of the invention.

FIG. 5 is a flowchart illustrating operation of a method for detecting IQ swap according to an embodiment of the invention.

FIG. 6 is a block diagram illustrating circuitry of the first correlator circuit and the second correlator circuit depicted in FIG. 4 according to an embodiment of the invention.

### DESCRIPTION OF THE EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

The term “coupling/coupled” used in this specification (including claims) may refer to any direct or indirect connection means. For example, “a first device is coupled to a second device” should be interpreted as “the first device is directly connected to the second device” or “the first device is indirectly connected to the second device through other devices or connection means.” Moreover, wherever appropriate in the drawings and embodiments, elements/components/steps with the same reference numerals represent the same or similar parts. Elements/components/steps with the same reference numerals or names in different embodiments may be cross-referenced.

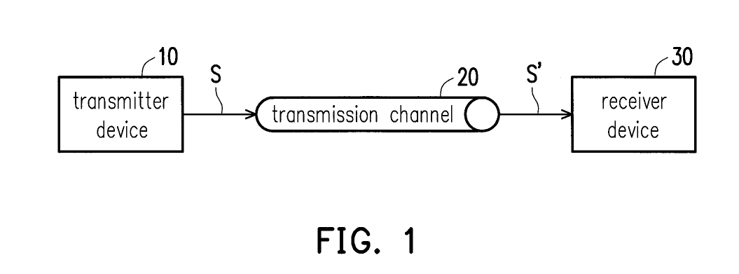

FIG. 1 is a schematic diagram illustrating a communication system according to an embodiment of the invention. The communication system includes a transmitter device 10 and a receiver device 30. The transmitter device 10 is capable of transmitting a signal S to the receiver device 30 in accordance with one or more communication protocols. The signal S may become a signal S′ due to a transmission of a transmission channel 20. The transmission channel 20 may be a wired channel (which uses a conductor as a transmission medium) or a wireless channel. If the transmission channel 20 is an ideal channel, the signal S′ is identical to the signal S. However, in practical application scenarios, the transmission channel 20 is not the ideal channel, such that the signal S′ and the signal S may not be the same. The receiver device 30 needs to have a capability of restoring the signal S′ back to the correct signal, so as to retrieve data identical to that of the signal S from the signal S′.

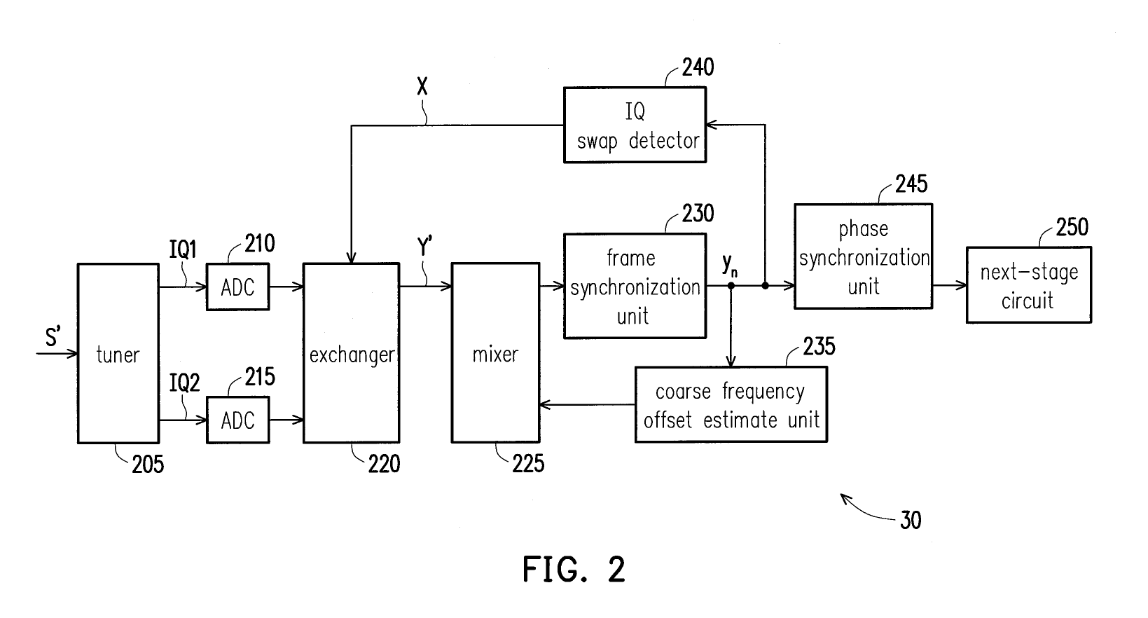

FIG. 2 is a block diagram illustrating circuitry of the receiver device 30 depicted in FIG. 1 according to an embodiment of the invention. The receiver device 30 includes a tuner 205, an analog-to-digital converter (ADC) 210, an analog-to-digital converter 215, an exchanger 220, a mixer 225, a frame synchronization unit 230, a coarse frequency offset estimate unit 235, an IQ swap detector 240 and a phase synchronization unit 245. The tuner 205 is capable of down-converting a passband signal S′ came from the transmission channel 20 into a baseband signal. The tuner 205 is capable of retrieving an in-phase component sand a quadrature component (i.e., the components IQ1 and IQ2 as depicted in FIG. 2) from the baseband signal. At this point, which one of the components IQ1 and IQ2 is the in-phase component (or the quadrature component) is still unknown.

The analog-to-digital converters 210 and 215 convert the analog components IQ1 and IQ2 into digital signals, and transmit the digital signals to the exchanger 220, respectively. Under control of the IQ swap detector 240, the exchanger 220 is capable of deciding whether to exchange the in-phase component and the quadrature component or not. For instance, when the digital signal outputted by the analog-to-digital converter 210 is the in-phase component I and the digital signal outputted by the analog-to-digital converter 215 is the quadrature component Q, in order to output a signal Y′=I+jQ, the exchanger 220 does not perform an exchange operation.

When the digital signal outputted by the analog-to-digital converter 210 is the quadrature component Q and the digital signal outputted by the analog-to-digital converter 215 is the in-phase component I, if the exchanger 220 does not perform the exchange operation, the exchanger 200 will output a signal Y′=I+jQ. This swap of the in-phase component I and the quadrature component Q may cause errors to occur in a subsequent demodulation of the communication system. For preventing the errors from occurring in the subsequent demodulation, the IQ swap detector 240 is capable of determining whether the in-phase component I and the quadrature component Q are swapped (which will be described in detail later). When the digital signal outputted by the analog-to-digital converter 210 is the quadrature component Q and the digital signal outputted by the analog-to-digital converter 215 is the in-phase component I, the exchanger 220 is capable of performing the exchange operation under control of the IQ swap detector 240, so as to output the signal Y′=I+jQ.

Based on an estimated result of the coarse frequency offset estimate unit 235, the mixer 225 is capable of compensating a frequency offset of the signal Y′. The frame synchronization unit 230 is capable of finding a frame header of a signal frame, so as to facilitate a received data to be correctly de-rotated and descrambled. When the frame head is found by the frame synchronization unit 230, known symbols (e.g., a physical layer header (or a PL header), a pilot, etc.) may then be indicated. The known symbols may be used for a frequency offset estimation or a phase synchronization. The frame synchronization unit 230 is capable of outputting a synchronized signal frame (i.e., a received symbol stream Y) to the coarse frequency offset estimate unit 235, the IQ swap detector 240 and the phase synchronization unit 245. yₙ depicted in FIG. 2 represents an n^{th} symbol of the received symbol stream Y. Therefore, the coarse frequency offset estimate unit 235 is capable of estimating the frequency offset of the signal Y′ according to the received symbol stream Y, and then providing the estimated result to the mixer 225. The IQ swap detector 240 is capable of determining whether the in-phase component I and the quadrature component Q in the signal Y′ are swapped according to the received symbol stream Y (which will be described in detail later), and then deciding whether to control the exchanger 220 to perform the exchange operation. The phase synchronization unit 245 is capable of performing a phase synchronization according to the received symbol stream Y.

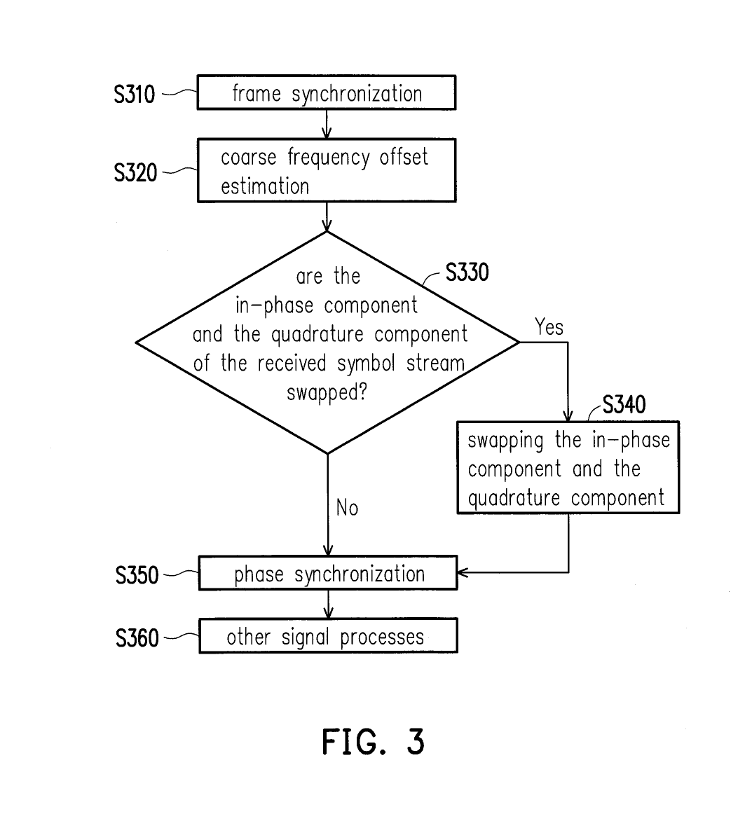

FIG. 3 is a flowchart illustrating operation of the receiver device 30 depicted in FIG. 2 according to an embodiment of the invention. In step S310, the frame synchronization unit 230 is capable of finding a frame head of a signal frame. When the frame head is found by the frame synchronization unit 230, known symbols (e.g., a physical layer header, a pilot, etc.) may then be found. The known symbols found in step S310 may be used for a frequency offset estimation in step S320. The frame synchronization unit 230 is capable of outputting a synchronized signal frame (i.e., a received symbol stream Y) to the coarse frequency offset estimate unit 235. yₙ depicted in FIG. 2 represents the n^{th} symbol of the received symbol stream Y. In step S320, the coarse frequency offset estimate unit 235 is capable of estimating the frequency offset of the signal Y′ according to the received symbol stream Y, and then providing an estimated result to the mixer 225. Based on the estimated result of the coarse frequency offset estimate unit 235, the mixer 225 is capable of compensating a frequency offset of the signal Y′, and then providing the signal frame (in which the frequency offset is compensated) to the frame synchronization unit 230. It is assumed herein that the frequency offset of the received symbol stream Y is Δf, and a frequency drift estimate in step S320 is Δfₑₛₜ. Because the frequency drift estimate Δfₑₛₜ in step S320 is capable of compensating most of the frequency offset Δf, a residual frequency drift amount Δfᵣ may be very small to even be ignored.

The frame synchronization unit 230 is also capable of outputting the synchronized signal frame (i.e., the received symbol stream Y) to the IQ swap detector 240. yₙ depicted in FIG. 2 represents the n^{th} symbol of the received symbol stream Y. Step S330 may be implemented after a coarse frequency offset estimation is completed and a coarse frequency offset compensation is completed. In step S330, the IQ swap detector 240 is capable of determining whether the in-phase component I and the quadrature component Q in the signal Y′ are swapped according to the received symbol stream Y (which will be described in detail later), and then deciding whether to control the exchanger 220 to perform an exchange operation for the in-phase component I and the quadrature component Q. If the IQ swap detector 240 decides to perform the exchange operation, the exchanger 220 swaps the in-phase component I and the quadrature component Q in step S340. In the circumstance where most of the frequency offset is eliminated, the IQ swap detector 240 is capable of calculating correlations of the received symbol stream Y. In some embodiments, the received symbol stream Y may be a PL header, a pilot's coefficients or other known symbol streams.

The known symbols found in step S310 may further be used for a phase synchronization. The frame synchronization unit 230 is capable of outputting a synchronized signal frame (i.e., a received symbol stream Y) to the phase synchronization unit 245. yₙ depicted in FIG. 2 represents the n^{th} symbol of the received symbol stream Y. In step S350, the phase synchronization unit 245 is capable of performing the phase synchronization according to the received symbol stream Y, and outputting the phase-synchronized signal frame to a next-stage circuit 250. The next-stage circuit 250 is capable of using the phase-synchronized signal frame for other signal processes in step S360.

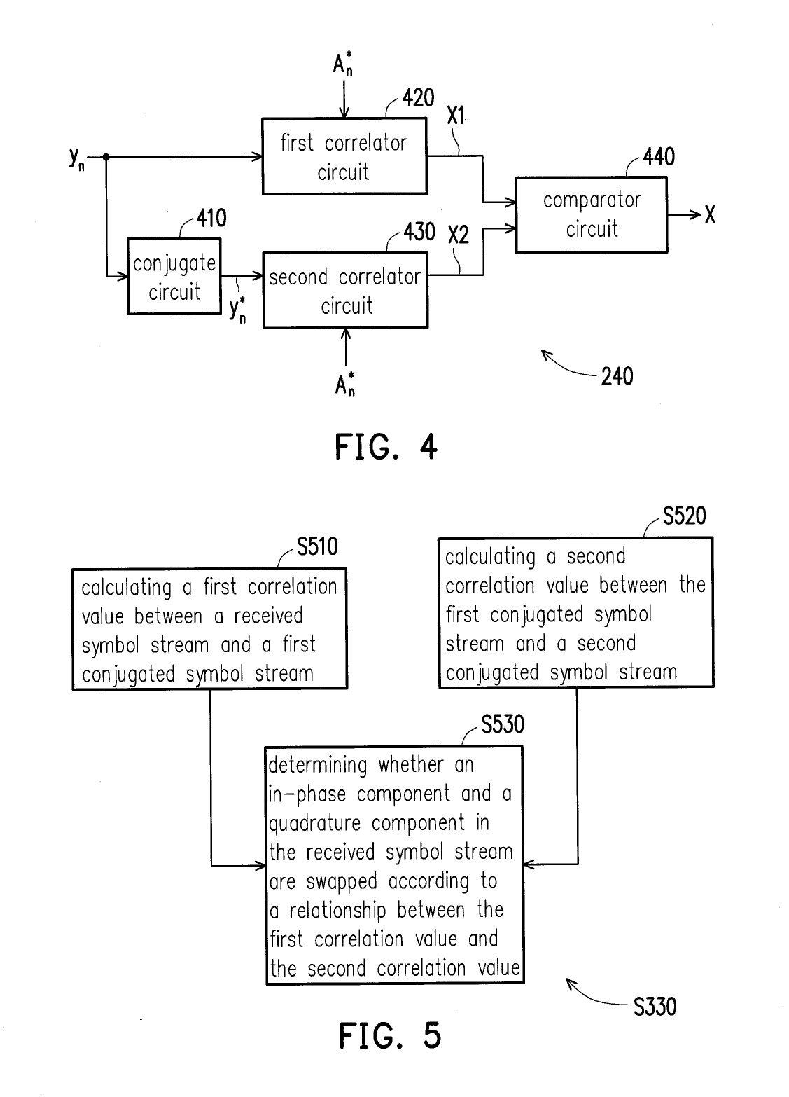

FIG. 4 is a block diagram illustrating circuitry of the IQ swap detector 240 depicted in FIG. 2 according to an embodiment of the invention. The IQ swap detector 240 depicted in FIG. 4 includes a conjugate circuit 410, a first correlator circuit 420, a second correlator circuit 430 and a comparator circuit 440. An input terminal of the conjugate circuit 410 is coupled to the frame synchronization unit 230 to receive the received symbol stream Y. yₙ depicted in FIG. 4 represents the n^{th} symbol of the received symbol stream Y. The conjugate circuit 410 converts the received symbol stream Y into a second conjugated symbol stream Y*, and the second conjugated symbol stream Y* is conjugate complex of the received symbol stream Y. In FIG. 4, yₙ* represents an n^{th} conjugated symbol of the second conjugated symbol stream Y*, and the conjugated symbol yₙ* is conjugate complex of a received symbol yₙ. An output terminal of the conjugate circuit 410 is coupled to an input terminal of the second correlator circuit 430 to provide the second conjugated symbol stream Y* to the second correlator circuit 430.

The received symbol stream Y is generated by a transmission of a known symbol stream A through a transmission channel (e.g., the transmission channel 20 depicted in FIG. 1). The transmitter device may transmit the known symbol stream A to the receiver device through the transmission channel. If the transmission channel is an ideal channel, the known symbol stream A outputted by the transmitter device and the received symbol stream Y received by the receiver device are of the same symbol stream. However, in practical application scenarios, the transmission channel may not be the ideal channel, such that the known symbol stream A and the received symbol stream Y may not be the same. The known symbol stream A may be any symbol stream already known in advance by both the transmitter device and the reception-side device. For instance, in some embodiments, the known symbol stream A may be an aggregation of known symbols 1+j, 1−j, −1+j, −1−j, 1, −1, j and/or −j, in which j represents \sqrt{−1}. In some other embodiments, the known symbol stream A may be an aggregation of known symbols of a+bj, a−bj, −a+bj and/or −a−bj, in which a and b are real numbers. In other embodiments, the known symbol stream A may be a training symbol stream of any communication protocol, a start-of-frame (SOF) symbol stream, a physical layer scrambling (PLS) symbol stream, a pilot symbol stream or other known symbol streams. The so-called “any communication protocol” may be a digital video broadcasting (DVB) communication protocol or other communication protocols.

FIG. 5 is a flowchart illustrating operation of a method for detecting IQ swap (step S330 depicted in FIG. 3) according to an embodiment of the invention. Referring to FIG. 4 and FIG. 5, in step S510, the first correlator circuit 420 receives a first conjugated symbol stream A* and a received symbol stream Y, and calculates a first correlation value X1 between the received symbol stream Y and the first conjugated symbol stream A*. The first conjugated symbol stream A* is conjugate complex of the known symbol stream A. For instance, an n^{th} conjugated symbol Aₙ* of the first conjugated symbol stream A* is conjugate complex of an n^{th} known symbol Aₙ of the known symbol stream A. In step S520, the second correlator circuit 430 receives the first conjugated symbol stream A* and a second conjugated symbol stream Y*, and calculates a second correlation value X2 between the first conjugated symbol stream A* and the second conjugated symbol stream Y*. In FIG. 4, Aₙ* represents an n^{th} conjugated symbol of the first conjugated symbol stream A*, and yₙ* represents an n^{th} conjugated symbol of the second conjugated symbol stream Y*.

If the quadrature component Q and the in-phase component I in the received symbol stream Y are not swapped, the first correlation value X1 outputted by the first correlator circuit 420 can be expressed as Equation 2 below, and the second correlation value X2 outputted by the second correlator circuit 430 can be expressed as Equation 3 below. In Equation 2 and Equation 3, frequency drift coefficient e^{j2πnΔfr} represents a frequency drift occurred in the transmission of the known symbol stream A through the transmission channel (e.g., the transmission channel 20 depicted in FIG. 1), in which Δfᵣ represents a residual frequency drift amount (i.e., a difference between a frequency drift Δf of the received symbol stream Y and a frequency drift estimate Δfₑₛₜ). The noise term νₙ represents the added noise through the transmission channel 20. Because the frequency drift estimate Δfₑₛₜ in step S320 is capable of compensating most of the frequency offset Δf, the residual frequency drift amount Δfᵣ may be very small to even be ignored. When Δfᵣ is very small and can be considered as 0, the second correlation value X2 is proximate to 0 because

$$\begin{matrix}{\sum }_{n} [ {A}_{n} ] = {\sum }_{n} ⌊ {( {A}_{n} )}^{2} ⌋ = {\sum }_{n} ⌊ {( {A}_{n}^{*} )}^{2} ⌋ = 0. & \\ \begin{matrix}X 1 = {\sum }_{n} {y}_{n} {A}_{n}^{*} \\ = {\sum }_{n} ( {A}_{n} {e}^{j 2 π n Δ {f}_{r}} + {v}_{n} ) {A}_{n}^{*} \\ = {\sum }_{n} ( {‖ {A}_{n} ‖}^{2} {e}^{j2 π n Δ {f}_{r}} + {A}_{n}^{*} {v}_{n} ) \\ \approx {\sum }_{n} ( {‖ {A}_{n} ‖}^{2} ) + {\sum }_{n} ( {A}_{n}^{*} {v}_{n} ) , if Δ {f}_{r} is very small\end{matrix} & Equation 2 \\ \begin{matrix}X 2 = {\sum }_{n} {y}_{n}^{*} {A}_{n}^{*} \\ = {\sum }_{n} ( {A}_{n}^{*} {e}^{- j 2 π n Δ {f}_{r}} + {v}_{n} ) {A}_{n}^{*} \\ = {\sum }_{n} ( ( {A}_{n}^{*} {A}_{n}^{*} ) {e}^{j2 π n Δ {f}_{r}} + {A}_{n}^{*} {v}_{n} ) \\ = {\sum }_{n} [ {( {A}_{n}^{*} )}^{2} {e}^{j 2 π n Δ {f}_{r}} + {A}_{n}^{*} {v}_{n} ] \\ \approx 0 + {\sum }_{n} [ {A}_{n}^{*} {v}_{n} ] , if Δ {f}_{r} is very small\end{matrix} & Equation 3\end{matrix}$$

A first input terminal of the comparator circuit 440 is coupled to an output terminal of the first correlator circuit 420 to receive the first correlation value X1. A second input terminal of the comparator circuit 440 is coupled to an output terminal of the second correlator circuit 430 to receive the second correlation value X2. According to a relationship between the first correlation value X1 and the second correlation value X2, the comparator circuit 440 is capable of determining whether the in-phase component I and the quadrature component Q in the received symbol stream Y are swapped in step S530. For instance (but the invention is not limited thereto), the comparator circuit 440 can compare magnitudes of the first correlation value X1 and the second correlation value X2. If the magnitude of the first correlation value X1 is greater than the magnitude of the second correlation value X2 (i.e., ∥X1∥>∥X2∥), the comparator circuit 440 can determine that the in-phase component I and the quadrature component Q in the received symbol stream Y are not swapped.

If the quadrature component Q and the in-phase component I in the received symbol stream Y are swapped, the first correlation value X1 outputted by the first correlator circuit 420 can be expressed as Equation 4 below, and the second correlation value X2 outputted by the second correlator circuit 430 can be expressed as Equation 5 below. If the magnitude of the first correlation value X1 is less than the magnitude of the second correlation value X2 (i.e., ∥X1∥<∥X2∥), the comparator circuit 440 can determine that the in-phase component I and the quadrature component Q in the received symbol stream Y are swapped.

$$\begin{matrix}\begin{matrix}X 1 = {\sum }_{n} {y}_{n} {A}_{n}^{*} \\ = {\sum }_{n} ( {A}_{n}^{*} {e}^{- j 2 π n Δ {f}_{r}} + {v}_{n} ) {A}_{n}^{*} \\ = {\sum }_{n} ( ( {A}_{n}^{*} ) {e}^{j2 π n Δ {f}_{r}} + {A}_{n}^{*} {v}_{n} ) \\ \approx 0 + {\sum }_{n} ( {A}_{n}^{*} {v}_{n} ) , if Δ {f}_{r} is very small\end{matrix} & Equation 4 \\ \begin{matrix}X 2 = {\sum }_{n} {y}_{n}^{*} {A}_{n}^{*} \\ = {\sum }_{n} ( {A}_{n} {e}^{j 2 π n Δ {f}_{r}} + {v}_{n} ) {A}_{n}^{*} \\ = {\sum }_{n} [ {‖ {A}_{n} ‖}^{2} {e}^{- j2 π n Δ {f}_{r}} + {A}_{n}^{*} {v}_{n} ] \\ \approx {\sum }_{n} [ {‖ {A}_{n} ‖}^{2} {e}^{- j2 π n Δ {f}_{r}} ] + {\sum }_{n} [ {A}_{n}^{*} {v}_{n} ] , if Δ {f}_{r} is very small\end{matrix} & Equation 5\end{matrix}$$

In some embodiments, the comparator circuit 440 can retrieve absolute values of a real part and an imaginary part for comparison, so as to know which one of the absolute values of the first correlation value X1 and the second correlation value X2 is greater. Accordingly, a circuitry complexity of the comparator circuit 440 may be simplified. For instance (but the invention is not limited thereto), the comparator circuit 440 can calculate Equation 6 below in order to obtain a difference D between the first correlation value X1 and the second correlation value X2. In Equation 6, Re {X1} represents the real part of the first correlation value X1, Im{X1} represents the imaginary part of the first correlation value X1, Re{X2} represents the real part of the second correlation value X2, and Im{X2}represents the imaginary part of the second correlation value X2.

$$\begin{matrix}D = X 1 - X 2 \\ = \vert Re \{ X 1 \} \vert + \vert Im \{ X 1 \} \vert = ( \vert Re \{ X 2 \} \vert + \vert Im \{ X 2 \} \vert )\end{matrix} \qquad Equation 6$$

When the difference D>0, it indicates that ∥X1∥>∥X2∥, which means that the quadrature component Q and the in-phase component I in the received symbol stream Y are not swapped. In this case, the comparator circuit 440 can control the exchanger 220 by adjusting a control signal X, so that the exchanger 220 does not perform the exchange operation. Accordingly, the exchangers 220 can then output the signal Y′=I+jQ.

When the difference D<0, it indicates that ∥X1∥<∥X2∥, which means that the quadrature component Q and the in-phase component I in the received symbol stream Y are swapped. In other words, if the exchanger 220 does not perform the exchange operation in this case, the exchanger 220 will output the signal Y′=Q+jI. The comparator circuit 440 can control the exchanger 220 by adjusting the control signal X, so that the exchanger 220 performs the exchange operation. Accordingly, the exchangers 220 can then output the correct signal Y′=I+jQ.

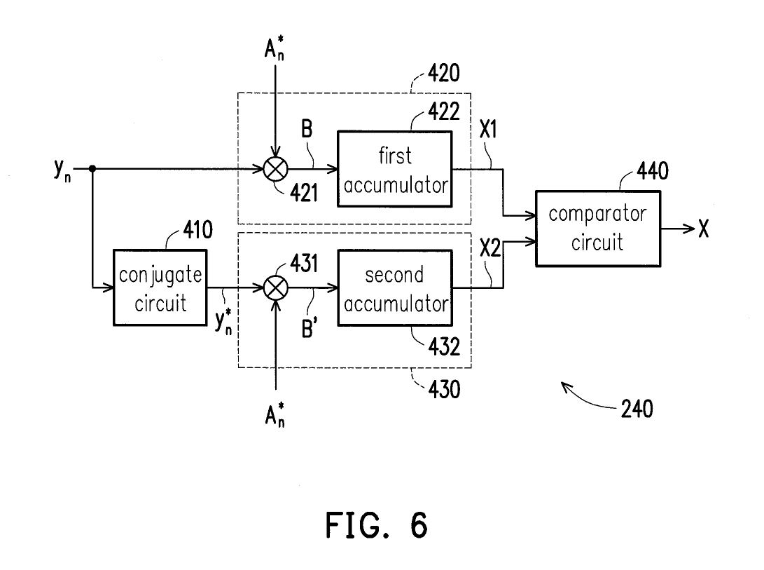

FIG. 6 is a block diagram illustrating circuitry of the first correlator circuit 420 and the second correlator circuit 430 depicted in FIG. 4 according to an embodiment of the invention. In FIG. 6, the first correlator circuit 420 includes a first multiplier 421 and a first accumulator 422. A first input terminal and a second input terminal of the first multiplier 421 receive the first conjugated symbol stream A* and the received symbol stream Y respectively. In FIG. 6, Aₙ* represents an n^{th} conjugated symbol of the first conjugated symbol stream A*, and yₙ represents an n^{th} received symbol of the received symbol stream Y. An output terminal of the first multiplier 421 outputs a first product value B, and the first product value B=Y*A*. An input terminal of the first accumulator 422 is coupled to the output terminal of the first multiplier 421 to receive and accumulate the first product value stream B, and outputs an accumulated result as the first correlation value X1. The first accumulator 422 outputs the first correlation value X1 to the comparator circuit 440.

The first multiplier 421 may be implemented by a multiplier of any form. In some embodiments, the first multiplier 421 may be implemented by using a non-multiplier in order to execute an equivalent operation of complex multiplication. For instance, in some other embodiments, the first multiplier 421 may include an addition and subtraction circuit. The addition and subtraction circuit is capable of executing the equivalent operation of complex multiplication. Accordingly, it is not required for the first multiplier 421 to include a complex multiplier with complex circuitry. For instance, it is assumed herein that an n^{th} symbol yₙ of the received symbol stream Y is s+jt, in which s and jt represent a real part and an imaginary part of the n^{th} symbol yₙ respectively. The addition and subtraction circuit of the first multiplier 421 is capable of using s and t for addition and subtraction operation to obtain a real part of an n^{th} symbol Bₙ of the first product value stream B, and using s and t for addition and subtraction operation to obtain an imaginary part of the n^{th} symbol Bₙ.

For instance (but the invention is not limited thereto), it is assumed herein that the known symbol stream A is an aggregation of known symbols 1+j, 1−j, −1+j, −1−j, 1, −1, j and −j, and an n^{th} known symbol Aₙ of the known symbol stream A is 1+j. An n^{th} conjugated symbol Aₙ* of the first conjugated symbol stream A* is 1−j. Therefore, in the first product value stream B, the n^{th} symbol Bₙ=yₙ*Aₙ*=(s+jt)*(1−j)=(s+t)+j(t−s). The addition and subtraction circuit of the first multiplier 421 is capable of calculating (s+t) to obtain the real part of the n^{th} symbol Bₙ, and calculating (t−s) to obtain the imaginary part of the n^{th} symbol Bₙ. Accordingly, the first multiplier 421 is capable of using the addition and subtraction circuit to execute the equivalent operation of complex multiplication (i.e., yₙ*Aₙ*) instead of using the complex multiplier with complex circuitry.

In the embodiment depicted in FIG. 6, the second correlator circuit 430 includes a second multiplier 431 and a second accumulator 432. A first input terminal and a second input terminal of the second multiplier 431 receive the first conjugated symbol stream A* and a second conjugated symbol stream respectively. yₙ* depicted in FIG. 6 represents an n^{th} conjugated symbol of the second conjugated symbol stream Y*. An output terminal of the second multiplier outputs a second product value B′=Y**Aₙ*. An input terminal of the second accumulator 432 is coupled to the output terminal of the second multiplier 431 to receive and accumulate the second product value stream B′, and outputs an accumulated result as the second correlation value X2. The second accumulator 432 outputs the second correlation value X2 to the comparator circuit 440.

The second multiplier 431 may be implemented by a multiplier of any form. In some embodiments, the second multiplier 431 may be implemented by using a non-multiplier in order to execute an equivalent operation of complex multiplication. For instance, in some other embodiments, the second multiplier 431 may include an addition and subtraction circuit. The addition and subtraction circuit is capable of executing the equivalent operation of complex multiplication. Accordingly, it is not required for the second multiplier 431 to include a complex multiplier with complex circuitry. For instance, it is assumed herein that an n^{th} symbol yₙ* of the second conjugated symbol stream Y* is s−jt, in which s and −jt represent a real part and an imaginary part of the n^{th} symbol yₙ* respectively. The addition and subtraction circuit of the second multiplier 431 is capable of using s and t for addition and subtraction operation to obtain a real part of an n^{th} symbol Bₙ′ of the second product value stream B′, and using s and t for addition and subtraction operation to obtain an imaginary part of the n^{th} symbol Bₙ′.

For instance (but the invention is not limited thereto), it is assumed herein that the known symbol stream A is an aggregation of known symbols 1+j, 1−j, −1+j, −1−j, 1, −1, j and −j, and an n^{th} known symbol Aₙ of the known symbol stream A is 1+j. An n^{th} conjugated symbol Aₙ* of the first conjugated symbol stream A* is 1−j. Therefore, in the second product value stream B′, the n^{th} symbol Bₙ′=yₙ**Aₙ*=(s−jt)*(1−j)=(s−t)+j(−s−t). The addition and subtraction circuit of the second multiplier 431 is capable of calculating (s−t) to obtain the real part of the n^{th} symbol Bₙ′, and calculating (−s−t) to obtain the imaginary part of the n^{th} symbol Bₙ′. Accordingly, the second multiplier 431 is capable of using the addition and subtraction circuit to execute the equivalent operation of complex multiplication (i.e., yₙ**Aₙ*) instead of using the complex multiplier with complex circuitry.

In summary, the detector and the method for detecting IQ swap according various embodiments of the invention are capable of determining whether the in-phase component I and the quadrature component Q are swapped. The IQ swap detector is capable of calculating the product of currently-received symbol yₙ and the previously-received symbol yₙ₋₁ without using the complex multiplier with complex circuitry.

Although the present invention has been described with reference to the above embodiments, it will be apparent to one of ordinary skill in the art that modifications to the described embodiments may be made without departing from the spirit of the invention. Accordingly, the scope of the invention will be defined by the attached claims and not by the above detailed descriptions.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

1. An IQ swap detector, comprising:
a first correlator circuit, receiving a first conjugated symbol stream and a received symbol stream, and calculating a first correlation value between the received symbol stream and the first conjugated symbol stream, wherein the received symbol stream is generated by a transmission of a known symbol stream through a transmission channel, and the first conjugated symbol stream is conjugate complex of the known symbol stream;
a second correlator circuit, receiving the first conjugated symbol stream and a second conjugated symbol stream, and calculating a second correlation value between the first conjugated symbol stream and the second conjugated symbol stream, wherein the second conjugated symbol stream is conjugate complex of the received symbol stream; and
a comparator circuit, coupled to the first correlator circuit to receive the first correlation value, coupled to the second correlator circuit to receive the second correlation value, and determining whether an in-phase component and a quadrature component in the received symbol stream are swapped according to a relationship between the first correlation value and the second correlation value,
wherein the first conjugated symbol stream and the received symbol stream are in time-domain.

2. The IQ swap detector as claimed in claim 1, further comprising:
a conjugate circuit, coupled to the second correlator circuit, and the conjugate circuit converting the received symbol stream into the second conjugated symbol stream to be provided to the second correlator circuit.

3. The IQ swap detector as claimed in claim 1, wherein the first correlator circuit comprises:
a first multiplier, having a first input terminal and a second input terminal for receiving the first conjugated symbol stream A* and the received symbol stream Y respectively, and an output terminal of the first multiplier outputting a first product value stream B=Y*A*; and
a first accumulator, having an input terminal coupled to the output terminal of the first multiplier to receive and accumulate the first product value stream B, and outputting an accumulated result as the first correlation value to the comparator circuit.

4. The IQ swap detector as claimed in claim 3, wherein an n^{th} symbol yₙ of the received symbol stream Y is s+jt, the first multiplier comprises an addition and subtraction circuit, the addition and subtraction circuit uses s and t for addition and subtraction operation to obtain a real part of an n^{th} symbol Bₙ of the first product value stream B, and uses s and t for addition and subtraction operation to obtain an imaginary part of the n^{th} symbol Bₙ, wherein s and jt represent a real part and an imaginary part of the n^{th} symbol yₙ respectively, and j represents \sqrt{−1}.

5. The IQ swap detector as claimed in claim 1, wherein the second correlator circuit comprises:
a second multiplier, having a first input terminal and a second input terminal for receiving the first conjugated symbol stream A* and the second conjugated symbol stream Y* respectively, and an output terminal of the second multiplier outputting a second product value stream B′=Y**A*; and
a second accumulator, having an input terminal coupled to the output terminal of the second multiplier to receive and accumulate the second product value stream B′, and outputting an accumulated result as the second correlation value to the comparator circuit.

6. The IQ swap detector as claimed in claim 1, wherein when the first correlation value is greater than the second correlation value, the comparator circuit determines that the in-phase component and the quadrature component in the received symbol stream are not swapped; and when the first correlation value is less than the second correlation value, the comparator circuit determines that the in-phase component and the quadrature component in the received symbol stream are swapped.

7. The IQ swap detector as claimed in claim 1, wherein the known symbol stream is a training symbol stream, a start-of-frame symbol stream, a physical layer scrambling symbol stream or a pilot symbol stream.

8. The IQ swap detector as claimed in claim 1, wherein a known symbol of the known symbol stream comprises 1+j, 1−j, −1+j, −j−1, j or −j.

9. A method for detecting IQ swap, comprising:
calculating a first correlation value between a received symbol stream and a first conjugated symbol stream by a first correlator circuit, wherein the received symbol stream is generated by a transmission of a known symbol stream through a transmission channel, and the first conjugated symbol stream is conjugate complex of the known symbol stream;
calculating a second correlation value between the first conjugated symbol stream and a second conjugated symbol stream by a second correlator circuit, wherein the second conjugated symbol stream is conjugate complex of the received symbol stream; and
determining whether an in-phase component and a quadrature component in the received symbol stream are swapped according to a relationship between the first correlation value and the second correlation value by a comparator circuit,
wherein the first conjugated symbol stream and the received symbol stream are in time-domain.

10. The method for detecting IQ swap as claimed in claim 9, further comprising:
converting the received symbol stream into the second conjugated symbol stream to be provided to the second correlator circuit by a conjugate circuit.

11. The method for detecting IQ swap as claimed in claim 9, wherein the step of calculating the first correlation value comprises:
calculating B=Y*A*, wherein Y represents the received symbol stream, A* represents the first conjugated symbol stream, and B represents a first product value stream of A* and Y; and
accumulating the first product value stream B, and outputting an accumulated result as the first correlation value to the comparator circuit.

12. The method for detecting IQ swap as claimed in claim 11, wherein an n^{th} symbol yₙ of the received symbol stream Y is s+jt, s and jt represent a real part and an imaginary part of the n^{th} symbol yₙ respectively, and j represents \sqrt{−1}, and the step of calculating B=Y*A* comprises:
using s and t for addition and subtraction operation by an addition and subtraction circuit to obtain a real part of an n^{th} symbol Bₙ of the first product value stream B, and
using s and t for addition and subtraction operation by the addition and subtraction circuit to obtain an imaginary part of the n^{th} symbol Bₙ.

13. The method for detecting IQ swap as claimed in claim 9, wherein the step of calculating the second correlation value comprises:
calculating B′=Y**A*, wherein Y* represents the second conjugated symbol stream, A* represents the first conjugated symbol stream, and B′ represents a second product value stream of A* and Y*; and
accumulating the second product value stream B′, and outputting accumulated result as the second correlation value to the comparator circuit.

14. The method for detecting IQ swap as claimed in claim 9, wherein the step of determining whether the in-phase component and the quadrature component in the received symbol stream are swapped comprises:
when the first correlation value is greater than the second correlation value, determining that the in-phase component and the quadrature component in the received symbol stream are not swapped; and
when the first correlation value is less than the second correlation value, determining that the in-phase component and the quadrature component in the received symbol stream are swapped.

15. The method for detecting IQ swap as claimed in claim 9, wherein the known symbol stream is a training symbol stream, a start-of-frame symbol stream, a physical layer scrambling symbol stream or a pilot symbol stream.

16. The method for detecting IQ swap as claimed in claim 9, wherein a known symbol of the known symbol stream comprises 1+j, 1−j, −1+j, −1−j, 1, −1, j or −j.
